(19) United States
(12) Patent Application Publication
(10) Pub. No.: US 2024/0212329 A1
(43) Pub. Date: Jun. 27, 2024

(54) METHOD FOR LEARNING ARTIFICIAL NEURAL NETWORK BASED KNOWLEDGE DISTILLATION AND COMPUTING DEVICE FOR EXECUTING THE SAME

(71) Applicant: University-Industry Cooperation Group of Kyung Hee University, Gyeonggi-do (KR)

(72) Inventors: EUI NAM HUH, Gyeonggi-do (KR); SHARMEN AKHTER, Gyeonggi-do (KR); YU RI SEO, Seoul (KR)

(21) Appl. No.: 18/543,075

(22) Filed: Dec. 18, 2023

(30) Foreign Application Priority Data
Dec. 26, 2022 (KR) 10-2022-0184978
Mar. 14, 2023 (KR) 10-2023-0033087

(51) Int. Cl. G06V 10/774; G06V 10/77; G06V 10/82

(52) U.S. Cl. CPC G06V 10/774; G06V 10/7715; G06V 10/82

(57) ABSTRACT

A method for learning the artificial neural network according to an embodiment includes training a teacher model including a preprocessor that preprocesses an input image to a certain size, a feature extractor including a plurality of sequential blocks for extracting a feature map from the preprocessed input image, and an output unit that outputs a predicted value based on the feature map, dividing the plurality of sequential blocks of the teacher model into separate blocks, respectively, generating a plurality of sub-student models by arranging the plurality of divided blocks in parallel, and training each of the plurality of sub-student models.

### CROSS-REFERENCE TO RELATED APPLICATION AND CLAIM OF PRIORITY

This application claims the benefit under 35 USC § 119 of Korean Patent Application Nos. 10-2022-0184978, filed on Dec. 26, 2022, and 10-2023-0033087, filed on Mar. 14, 2023, in the Korean Intellectual Property Office, the entire disclosure of which are incorporated herein by reference for all purposes.

### BACKGROUND

### 1. Field

Embodiments of the present disclosure relate to an artificial neural network architecture based on knowledge distillation for faster inference while providing baseline performance.

### 2. Description of Related Art

Recently, deep learning-based technologies have shown high performance in various fields and tasks such as surveillance systems, autonomous driving, and real-time computing of edge devices. However, high-performance deep learning models require a lot of computing resources because they have millions of parameters and require a large amount of computation. Therefore, it is difficult to perform deep learning-based applications in real time on devices with limited computing resources (e.g., Internet of Things devices, edge devices, or mobile devices, and the like). This complexity of deep neural networks demands relatively more inference time during execution at the low computational resource devices due to the sequential forward propagation nature.

### SUMMARY

Embodiments of the present disclosure are intended to provide a method for training an artificial neural network based knowledge distillation that allows an application to be executed in real time on a device having limited computing resources, and a computing device for performing the same.

According to an exemplary embodiment of the present disclosure, there is provided a method for learning an artificial neural network performed on a computing device including one or more processors and a memory that stores one or more programs executed by the one or more processors, the method including training a teacher model including a preprocessor that preprocesses an input image to a certain size, a feature extractor including a plurality of sequential blocks for extracting a feature map from the preprocessed input image, and an output unit that outputs a predicted value based on the feature map, dividing the plurality of sequential blocks of the teacher model into separate blocks, respectively, generating a plurality of sub-student models by arranging the plurality of divided blocks in parallel, and training each of the plurality of sub-student models.

The generating of the plurality of sub-student models may include arranging the plurality of divided blocks in order in respective feature extractors of the plurality of sub-student models arranged in parallel.

Each of the plurality of sub-student models may receive the same input image as input.

The generating of the plurality of sub-student models may include arranging a preprocessor that preprocess the input image to a different size at a front stage of each feature extractor in each sub-student model.

The arranging of the preprocessor may include arranging the preprocessor capable of preprocessing the input image to the same size as the preprocessor of the teacher model in a first sub-student model, and arranging the preprocessor capable of preprocessing the input image to the same size as a feature map output from an (n-1)-th block of the teacher model, in an n-th sub-student model (n is a natural number greater than or equal to 2 and less than or equal to the total number of blocks in the teacher model).

The generating of the plurality of sub-student models may further include arranging an output unit that outputs a predicted value for the input image based on a feature map output from each feature extractor of each sub-student model at a rear stage of the feature extractor.

The plurality of sub-student models may have a first loss function, which is a loss function between the predicted value output from the output unit of each sub-student model and a preset ground truth, a second loss function, which is a loss function between the predicted value output from the output unit of each sub-student model and a predicted value output from the output unit of the teacher model, and a third loss function, which is a loss function between a feature map generated from a block of the feature extractor of each sub-student model and a feature map generated from a block of the corresponding feature extractor of the teacher model.

A total loss function of each sub-student model may be expressed by the following equation.

$$ℒ = {λ}_{1} {ℒ}_{ce} + {λ}_{2} {ℒ}_{kd} + {ℒ}_{feature} \qquad [ Equation ]$$

[symbol] ce: first loss function
[symbol] kd: second loss function
[symbol] feature: third loss function, and
λ₁ and λ₂: preset weights

The method for learning the artificial neural network may further include calculating, if the input image is input to each of the plurality of sub-student models when training of the plurality of sub-student models is completed, a final predicted value based on predicted values output from the plurality of sub-student models.

According to another exemplary embodiment of the present disclosure, there is provided a computing device including one or more processors, a memory, and one or more programs, in which the one or more programs are stored in the memory and configured to be executed by the one or more processors, and the one or more programs include an instruction for training a teacher model including a preprocessor that preprocesses an input image to a certain size, a feature extractor including a plurality of sequential blocks for extracting a feature map from the preprocessed input image, and an output unit that outputs a predicted value based on the feature map, an instruction for dividing the plurality of sequential blocks of the teacher model into separate blocks, respectively, an instruction for generating a plurality of sub-student models by arranging the plurality of divided blocks in parallel, and an instruction for training each of the plurality of sub-student models.

The instruction for generating of the plurality of sub-student models may include an instruction for arranging the plurality of divided blocks in order in respective feature extractors of the plurality of sub-student models arranged in parallel.

Each of the plurality of sub-student models may receive the same input image as input.

The instruction for generating of the plurality of sub-student models may include an instruction for arranging a preprocessor that preprocess the input image to a different size at a front stage of each feature extractor in each sub-student model.

The instruction for arranging of the preprocessor may include an instruction for arranging the preprocessor capable of preprocessing the input image to the same size as the preprocessor of the teacher model in a first sub-student model, and an instruction for arranging the preprocessor capable of preprocessing the input image to the same size as a feature map output from an (n-1)-th block of the teacher model, in an n-th sub-student model (n is a natural number greater than or equal to 2 and less than or equal to the total number of blocks in the teacher model).

The instruction for generating of the plurality of sub-student models may further include an instruction for arranging an output unit that outputs a predicted value for the input image based on a feature map output from each feature extractor of each sub-student model at a rear stage of the feature extractor.

The plurality of sub-student models may have a first loss function, which is a loss function between the predicted value output from the output unit of each sub-student model and a ground truth, a second loss function, which is a loss function between the predicted value output from the output unit of each sub-student model and a predicted value output from the output unit of the teacher model, and a third loss function, which is a loss function between a feature map generated from a block of the feature extractor of each sub-student model and a feature map generated from a block of the corresponding feature extractor of the teacher model.

The one or more programs may further include an instruction for calculating, if the input image is input to each of the plurality of sub-student models when training of the plurality of sub-student models is completed, a final predicted value based on predicted values output from the plurality of sub-student models.

### BRIEF DESCRIPTION OF THE DRAWINGS

FIG. 1 is a diagram illustrating an artificial neural network architecture according to an embodiment of the present disclosure.

FIG. 2 is a diagram illustrating a second loss function and a third loss function between a first sub-student model and a teacher model in an embodiment of the present disclosure.

FIGS. 3A and 3B are diagrams comparing the total execution time of the teacher model and the total execution time of the student model in an embodiment of the present disclosure.

FIG. 4 is a block diagram for illustratively describing a computing environment including a computing device suitable for use in exemplary embodiments.

FIG. 5 is a flowchart illustrating a learning method of an artificial neural network according to an embodiment of the present disclosure.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

Additionally, terms such as first, second, etc. may be used to describe various components, but the components should not be limited by the terms. Terms may be used for the purpose of distinguishing one component from another. For example, a first component may be referred to as a second component, and similarly, the second component may also be referred to as a first component without departing from the scope of the present disclosure.

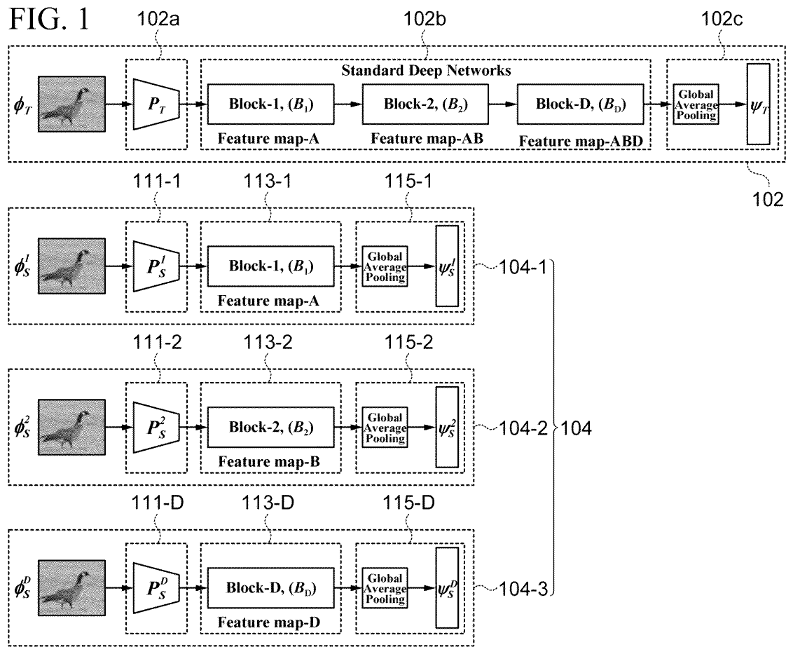

FIG. 1 is a diagram illustrating an artificial neural network architecture according to an embodiment of the present disclosure.

Referring to FIG. 1, an artificial neural network architecture 100 may include a teacher model 102 and a student model 104. The artificial neural network architecture 100 may be an artificial neural network architecture based on knowledge distillation.

The teacher model 102 is a machine learning model that has already been trained for a task intended to be performed by the student model 104 and may mean a model having a larger neural network size than the student model 104. Here, the larger neural network size may mean that the number of neural network layers, kernels, nodes, or parameters is greater than that of the student model 104. The student model 104 is a machine learning model trained using knowledge acquired from the pre-trained teacher model 102, and may mean a model having a smaller neural network size than the teacher model 102.

The teacher model 102 may include a preprocessor 102a, a feature extractor 102b, and an output unit 102c. The preprocessor 102a may receive a input image and perform pre-processing thereon. The preprocessor 102a may convert the input image into a preset number of channels.

The feature extractor 102b may be a neural network that extracts a feature from the input image. The neural network of the feature extractor 102b may include a plurality of blocks Block-1 to Block-D. D is the total number of blocks. The plurality of blocks Block-1 to Block-D may be connected sequentially. That is, an output of the first block Block-1 may be input to the second block Block-2, and an output of the second block Block-2 may be input to the third block Block-3. Here, for convenience of description, it is illustrated as an example that the number of blocks is three. Each block may be a neural network having one or more layers.

In one embodiment, the first block Block-1 may generate a feature map A from the preprocessed input image. The second block Block-2 may receive the feature map A as input and generate a feature map AB. In this way, the D-th block Block-D may receive the feature map AB from a block in a front stage thereof and generate a feature map ABD.

The output unit 102c may output a predicted value for the input image based on the feature output from the feature extractor 102b. Here, the predicted value may vary depending on the task intended to be performed by the teacher model 102. In one embodiment, if the task intended to be performed by the teacher model 102 is object recognition for the input image, the output unit 102c may output a classification value for an object in the input image. To this end, the output unit 102c may include a global average pooling layer and a classifier ψT.

The student model 104 may include a plurality of sub-student models 104-1, 104-2, to 104-D. The plurality of sub-student models 104-1, 104-2, . . . 104-D may be arranged in parallel. The plurality of sub-student models may be prepared in the same number as the number of blocks in the feature extractor 102b of the teacher model 102. The sub-student models may include preprocessors 111-1, 111-2, . . . , 111-D, feature extractors 113-1, 113-2, 113-D, and output units 115-1, 115-2, . . . , 115-D, respectively. Each of the plurality of sub-student models 104-1, 104-2, . . . 104-D may receive the input image as input.

The feature extractors 113-1, 113-2, . . . , 113-D of the plurality of sub-student models 104-1, 104-2, . . . 104-D may include one block among the plurality of blocks of the feature extractor 102b of the teacher model 102. In one embodiment, each sub-student model may include a block in an order corresponding thereto among the plurality of blocks of the feature extractor 102b. Hereinafter, it will be described as an example that each sub-student model has the block in the order corresponding thereto among the plurality of blocks of the feature extractor 102b, but is not limited thereto, and the block may be arranged regardless of order.

For example, the first feature extractor 113-1 may include a first block Block-1 of the feature extractor 102b. The second feature extractor 113-2 may include a second block Block-2 of the feature extractor 102b. The D-th feature extractor 113-D may include a D-th block Block-D of the feature extractor 102b. That is, in the teacher model 102, a plurality of blocks Block-1 to Block-D are sequentially connected (connected in series), but in the student model 104, the plurality of blocks Block-1 to Block-D are arranged in parallel. In this case, the first feature extractor 113-1 may generate a feature map A from the input image preprocessed by the first preprocessor 111-1. The second feature extractor 113-2 may generate a feature map B from the input image preprocessed by the second preprocessor 111-2. The D-th feature extractor 113-D may generate a feature map D from the input image preprocessed by the D-th preprocessor 111-D.

Here, since each of the plurality of sub-student models 104-1, 104-2, . . . 104-D receives the input image, each of the preprocessors 111-1, 111-2, . . . , 111-D of the plurality of sub-student models 104-1, 104-2, . . . 104-D may preprocess the input image into a different size.

The first preprocessor 111-1 may preprocess the input image to the same size as that in the preprocessor 102a of the teacher model 102. The second preprocessor 111-2 may preprocess the input image to have the same size as the feature map output from the first block Block-1.

That is, in the teacher model 102, the second block Block-2 is in a state of being trained using the feature map output from the first block Block-1 as input, and thus, in the second sub-student model 104-2, the second preprocessor 111-2 may preprocess the input image to have the same size as the feature map output from the first block Block-1. Likewise, the D-th preprocessor 111-D may preprocess the input image to have the same size as the size of the feature map output from the second block Block-2. Here, D corresponds to the case assuming that there are three preprocessors.

For example, the first preprocessor 111-1 may preprocess the input image to a size of 32×32. The second preprocessor 111-2 may preprocess the input image to a size of 16×16. The D-th preprocessor 111-D may preprocess the input image to a size of 8×8. That is, the input image may be preprocessed to a smaller size as it moves from the first preprocessor 111-1 to the D-th preprocessor 111-D.

The output units 115-1, 115-2, . . . , 115-D of the plurality of sub-student models 104-1, 104-2, . . . 104-D may have a structure corresponding to the output unit 102c of the teacher model 102. Each of the output units 115-1, 115-2, . . . , 115-D may output a predicted value for the input image based on the feature map output from each of the feature extractors 113-1, 113-2, . . . , 113-D. In one embodiment, like the output unit 102c of the teacher model 102, the output units 115-1, 115-2, . . . , 115-D may include global average pooling layers and classifiers ψs¹, ψs², . . . , ψs^{D}, respectively, and may be prepared to output classification values for the objects in the input image.

Meanwhile, the student model 104 may be trained by knowledge distillation from the teacher model 102. Here, since each of the feature extractors 113-1, 113-2, . . . , 113-D of the plurality of sub-student models 104-1, 104-2, . . . 104-D includes only any one of the blocks in the feature extractor 102b of the teacher model 102, and thus some feature extraction capability is lost and abstracted features cannot be extracted and only direct features are generated, and a problem in which induced bias of weakens as the depth of the neural network decreases may occur.

Accordingly, in the disclosed embodiment, this problem can be solved by not only calculating the loss function between the predicted value of the output unit 102C of the teacher model 102 and the predicted value of the output unit of the student model 104 and the loss function between the predicted value of the output unit of the student model 104 and the ground truth, but also calculating the loss function between the feature map generated from each block of the teacher model 102 and the feature map generated from each block of the student model 104.

Specifically, training of the student model 104 may occur between the sub-student models 104-1, 104-2, . . . 104-D and the teacher model 102. Each of the sub-student models 104-1, 104-2, . . . 104-D may have three loss functions as objective functions.

Each sub-student model may have the first loss function, which is a loss function between the predicted value output from the output unit of the corresponding sub-student model and the ground truth. The first loss function may be a cross-entropy loss between the predicted value output from the output unit of the sub-student model and the ground truth.

Each sub-student model may have the second loss function, which is a loss function between the predicted value output from the corresponding output unit and the predicted value output from the output unit 102c of the teacher model 102. Additionally, each sub-student model may have the third loss function, which is a loss function between the feature map generated from the block of the corresponding feature extractor and the feature map generated from the block corresponding thereto of the feature extractor 102b of the teacher model 102.

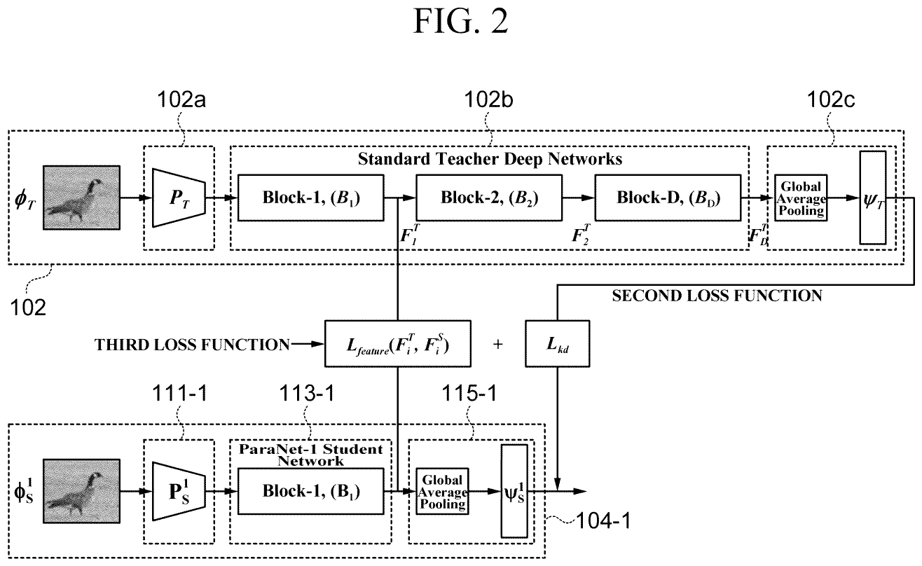

FIG. 2 is a diagram illustrating the second loss function and the third loss function between the first sub-student model 104-1 and the teacher model 102 in one embodiment of the present disclosure. Referring to FIG. 2, the first sub-student model 104-1 may have the second loss function between the predicted value output from the first output unit 115-1 and the predicted value output from the output unit 102c of the teacher model 102.

In one embodiment, the second loss function may be a loss by logit distillation. The logit distillation may be a method of learning to minimize the difference between a soft label (probability of each class being ground truth) of the predicted value predicted by the teacher model 102 and a soft label of the predicted value predicted by the first sub-student model 104-1. Here, probability distribution by the soft label can be expressed as Equation 1 below.

$${p}^{i} ( x ; τ ) = softmax ( ϕ ( x ) ; τ ) = \frac{{e}^{{ϕ}_{i} ( x ) / τ}}{{\sum }_{k} {e}^{{ϕ}_{k} ( x ) / τ}} \qquad [ Equation 1 ]$$

x: input
Øᵢ: i-th logit
k: total number of logits
τ: temperature

In Equation 1, the numerator may mean a value at which a value of the i-th logit among the entire logit matrix is activated, and the denominator may mean the sum of activated values of elements of the logit matrix.

And, the second loss function [symbol] kd by logit distillation can be expressed as Equation 2 below.

$${ℒ}_{kd} = - {τ}^{2} {\sum }_{x ∼ {D}_{x}} {\sum }_{i = 1}^{C} {p}_{{ϕ}_{τ}}^{i} ( x ; τ ) log ( {p}_{{ϕ}_{L}}^{i} ( x ; τ ) ) \qquad [ Equation 2 ]$$

Ø_{T}: teacher model
Ø_{L}: sub-student model
C: number of classes
Dₓ: number of input data sets

In Equation 2, P_{ϕT}ⁱ(χ;τ) means a soft label value of the teacher model, and P_{ϕL}ⁱ(χ;τ) means a soft label value of the sub-student model.

Additionally, the first sub-student model 104-1 may have a third loss function between a feature map Fᵢ^{s} generated from the block of the first feature extractor 113-1 and a feature map Fᵢ^{T} generated from the first block of the feature extractor 102b of the teacher model 102. In one embodiment, the third loss function can be expressed such that the distance between the feature map Fᵢ^{s} and the feature map Fᵢ^{T} is minimized. In one embodiment, the third loss function [symbol] feature can be expressed as Equation 3 below.

$${ℒ}_{feature} ( {ℱ}_{i}^{T} , {ℱ}_{i}^{S} ) = {‖ {ℱ}_{i}^{T} - {ℱ}_{i}^{S} ‖}_{2}^{2} \qquad [ Equation 3 ]$$

Fᵢ^{T}: feature map generated from i-th block in feature extractor of teacher model
Fᵢ^{S}: feature map generated from block in feature extractor of i-th sub-student model

Then, the total loss function for training each sub-student model can be expressed as Equation 4 below.

$$ℒ = {λ}_{1} {ℒ}_{ce} + {λ}_{2} {ℒ}_{kd} + {ℒ}_{feature} \qquad [ Equation 4 ]$$

[symbol] ce: first loss function
[symbol] kd: second loss function
[symbol] feature third loss function
λ₁ and λ₂: preset weights
λ₁ and λ₂ are balancing hyperparameters. In one embodiment, λ₁ and λ₂ may be 1 and 0.8, respectively, but are not limited thereto.

Meanwhile, if the input image is input to each of the sub-student models 104-1, 104-2, . . . 104-D in an inference step when training of each of the sub-student models 104-1, 104-2, . . . 104-D is completed, a final predicted value can be calculated based on the predicted value output from each of the sub-student models 104-1, 104-2, . . . 104-D.

That is, the final predicted value can be calculated by ensembling the predicted values output from the respective sub-student models 104-1, 104-2, . . . 104-D. In one embodiment, the final predicted value can be calculated by averaging the predicted values output from the respective sub-student models 104-1, 104-2, . . . 104-D, selecting a representative value thereof, or assigning each weight thereto.

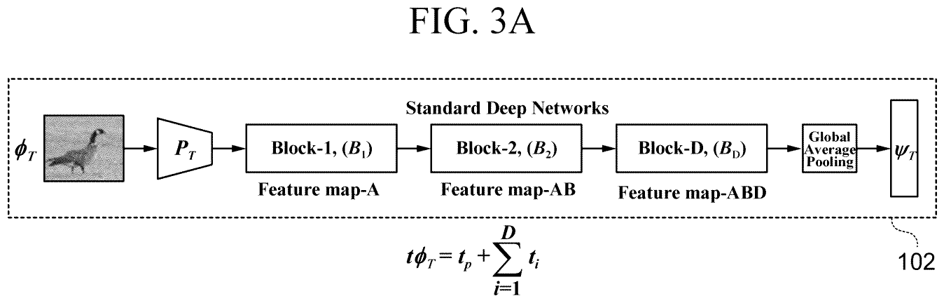

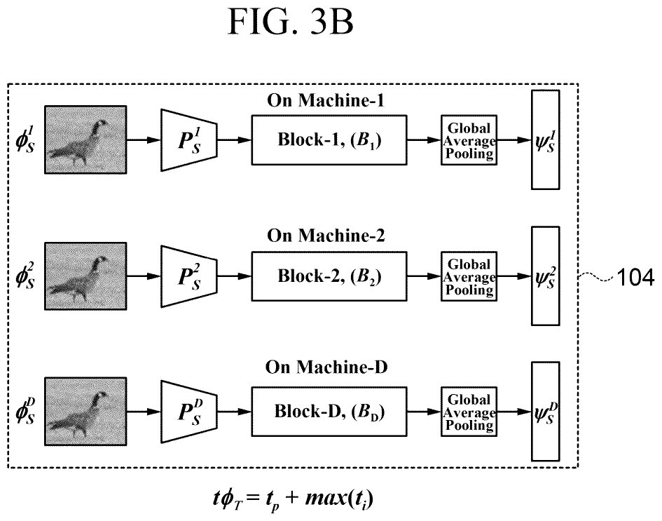

FIGS. 3A and 3B are diagrams comparing the total execution time of the teacher model 102 and the total execution time of the student model 104 in one embodiment of the present disclosure. Referring to FIG. 3A, the total execution time tor of the teacher model 102 can be expressed by Equation 5 below.

$${t}_{{ϕ}_{T}} = {t}_{p} + {\sum }_{i = 1}^{D} {t}_{i} \qquad [ Equation 5 ]$$

tₚ: time required to preprocess input image
tᵢ: execution time of i-th block of feature extractor
D: total number of blocks in feature extractor

That is, in the case of the teacher model 102, the total execution time tor is a value obtained by adding the total sum of the execution times of the blocks Block-1 to Block-D to the time required to preprocess the input image.

On the other hand, referring to FIG. 3B, the total execution time t_{ØT} of the student model 104 can be expressed by Equation 6 below.

$${t}_{{ϕ}_{T}} = {t}_{p} + max ( {t}_{i} ) \qquad [ Equation 6 ]$$

tₚ: time required to preprocess input image
max(tᵢ): maximum value of execution time of i-th block

That is, in the case of the student model 104, the total execution time t_{ØT} is a value obtained by adding the maximum value among the execution times of the blocks of the feature extractors to the time required to preprocess the input image.

Here, assuming that the time required to preprocess the input image is the same for the teacher model 102 and the student model 104, in the teacher model 102, a plurality of blocks are sequentially connected in the feature extractor 102b, and thus the total sum of the execution times of the respective blocks becomes the total execution time, whereas, in the student model 104, the feature extractors 113-1, 113-2, . . . , 113-D are arranged in parallel, and thus the maximum execution time of the block among the blocks of the feature extractors 113-1, 113-2, . . . , 113-D becomes the total execution time. Therefore, the student model 104 not only has a smaller size of the artificial neural network than that of the teacher model 102, but also can effectively shorten the execution time of the task.

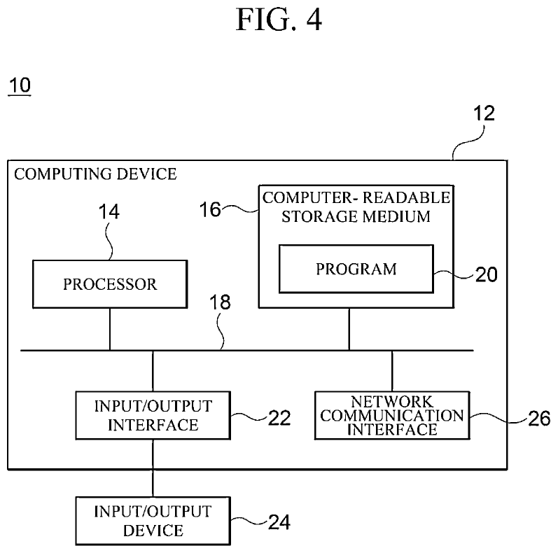

FIG. 4 is a block diagram for illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In one embodiment, the computing device 12 may be a device that includes the artificial neural network architecture 100. Additionally, the computing device 12 may be a device for training the artificial neural network architecture 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

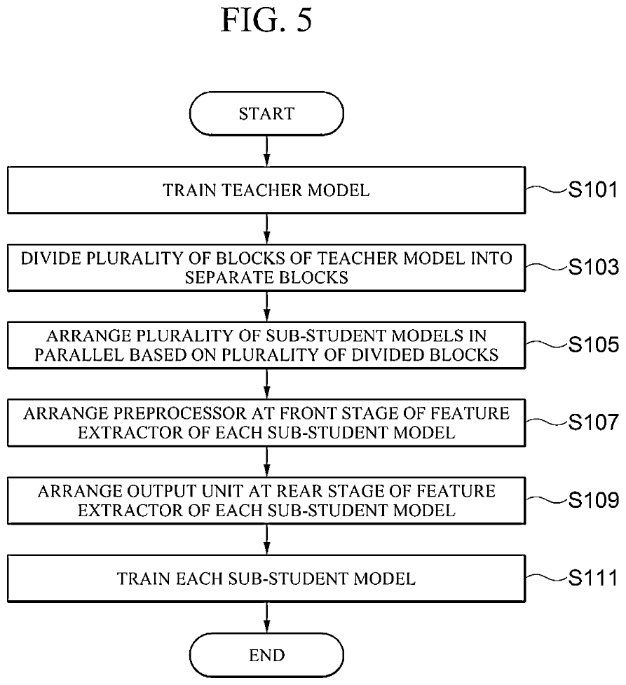

FIG. 5 is a flowchart illustrating a learning method of the artificial neural network according to an embodiment of the present disclosure. In the illustrated flowchart, the method is described by being divided into a plurality of steps, but at least some of the steps may be performed in a different order, may be performed together in combination with other steps, omitted, may be performed by being divided into detailed steps, or may be performed by being added with one or more steps (not illustrated).

Referring to FIG. 5, the computing device 12 can train the teacher model 102 (S101). In one embodiment, the teacher model 102 may be trained using a preset training data set for the task to be performed by the student model 104.

Next, the computing device 12 may divide the feature extractor 102b of the teacher model 102 into a plurality of blocks (S103). That is, the computing device 12 may divide a plurality of sequentially connected blocks of the feature extractor 102b into separate blocks, respectively.

Next, the computing device 12 may arrange a plurality of sub-student models in parallel based on the plurality of divided blocks (S105). The computing device 12 may arrange the plurality of divided blocks in the feature extractors of the sub-student models in order.

Next, the computing device 12 may arrange a preprocessor at a front stage of the feature extractor of each sub-student model (S107). In this case, the computing device 12 may allow the first preprocessor 111-1 to preprocess the input image to the same size as that in the preprocessor 102a of the teacher model 102. Additionally, the computing device 12 may allow an n-th preprocessor (111-n) (n-th preprocessor in the student model) to preprocess the input image to the same size as the size of the feature map output from an (n-1)-th block of the teacher model 102.

Next, the computing device 12 may arrange an output unit at a rear stage of the feature extractor of each sub-student model (S109). Each output unit of each sub-student model may be prepared to output a predicted value for the input image based on the feature map output from the corresponding feature extractor.

Next, the computing device 12 can train each sub-student model (S111). The computing device 12 may train each sub-student model to minimize the first loss function, the second loss function, and the third loss function.

According to embodiments of the present disclosure, since the plurality of sub-student models are arranged in parallel, the total execution time for the task can be reduced, and thus the present disclosure can be applied to applications that require real-time services.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

What is claimed is:

1. A method for learning an artificial neural network performed on a computing device including one or more processors and a memory that stores one or more programs executed by the one or more processors, the method comprising:
training a teacher model including a preprocessor that preprocesses an input image to a certain size, a feature extractor including a plurality of sequential blocks for extracting a feature map from the preprocessed input image, and an output unit that outputs a predicted value based on the feature map;
dividing the plurality of sequential blocks of the teacher model into separate blocks, respectively;
generating a plurality of sub-student models by arranging the plurality of divided blocks in parallel; and
training each of the plurality of sub-student models.

2. The method of claim 1, wherein the generating of the plurality of sub-student models includes:
arranging the plurality of divided blocks in order in respective feature extractors of the plurality of sub-student models arranged in parallel.

3. The method of claim 2, wherein each of the plurality of sub-student models receives the same input image as input.

4. The method of claim 3, wherein the generating of the plurality of sub-student models includes:
arranging a preprocessor that preprocess the input image to a different size at a front stage of each feature extractor in each sub-student model.

5. The method of claim 4, wherein the arranging of the preprocessor includes:
arranging the preprocessor capable of preprocessing the input image to the same size as the preprocessor of the teacher model in a first sub-student model; and
arranging the preprocessor capable of preprocessing the input image to the same size as a feature map output from an (n-1)-th block of the teacher model, in an n-th sub-student model, wherein n is a natural number greater than or equal to 2 and less than or equal to the total number of blocks in the teacher model.

6. The method of claim 5, wherein the generating of the plurality of sub-student models further includes:
arranging an output unit that outputs a predicted value for the input image based on a feature map output from each feature extractor of each sub-student model at a rear stage of the feature extractor.

7. The method of claim 6, wherein the plurality of sub-student models has a first loss function, which is a loss function between the predicted value output from the output unit of each sub-student model and a preset ground truth, a second loss function, which is a loss function between the predicted value output from the output unit of each sub-student model and a predicted value output from the output unit of the teacher model, and a third loss function, which is a loss function between a feature map generated from a block of the feature extractor of each sub-student model and a feature map generated from a block of the corresponding feature extractor of the teacher model.

8. The method of claim 7, wherein the total loss function of each sub-student model is expressed by the following equation:
$$ℒ = {λ}_{1} {ℒ}_{ce} + {λ}_{2} {ℒ}_{kd} + {ℒ}_{feature} \qquad [ Equation ]$$
wherein [symbol] ce is first loss function; [symbol]
kd is second loss function; [symbol]
feature is third loss function; and
λ₁ and λ₂ are preset weights.

9. The method of claim 1, further comprising:
calculating, if the input image is input to each of the plurality of sub-student models when training of the plurality of sub-student models is completed, a final predicted value based on predicted values output from the plurality of sub-student models.

10. A computing device comprising:
one or more processors;
a memory; and
one or more programs stored in the memory and configured to be executed by the one or more processors, the one or more programs including:
an instruction for training a teacher model including a preprocessor that preprocesses an input image to a certain size, a feature extractor including a plurality of sequential blocks for extracting a feature map from the preprocessed input image, and an output unit that outputs a predicted value based on the feature map;
an instruction for dividing the plurality of sequential blocks of the teacher model into separate blocks, respectively;
an instruction for generating a plurality of sub-student models by arranging the plurality of divided blocks in parallel; and
an instruction for training each of the plurality of sub-student models.

11. The computing device of claim 10, wherein the instruction for generating of the plurality of sub-student models includes:
an instruction for arranging the plurality of divided blocks in order in respective feature extractors of the plurality of sub-student models arranged in parallel.

12. The computing device of claim 11, wherein each of the plurality of sub-student models receives the same input image as input.

13. The computing device of claim 12, wherein the instruction for generating of the plurality of sub-student models includes:
an instruction for arranging a preprocessor that preprocess the input image to a different size at a front stage of each feature extractor in each sub-student model.

14. The computing device of claim 13, wherein the instruction for arranging of the preprocessor includes:
an instruction for arranging the preprocessor capable of preprocessing the input image to the same size as the preprocessor of the teacher model in a first sub-student model; and
an instruction for arranging the preprocessor capable of preprocessing the input image to the same size as a feature map output from an (n-1)-th block of the teacher model, in an n-th sub-student model (n is a natural number greater than or equal to 2 and less than or equal to the total number of blocks in the teacher model).

15. The computing device of claim 14, wherein the instruction for generating of the plurality of sub-student models further includes:
an instruction for arranging an output unit that outputs a predicted value for the input image based on a feature map output from each feature extractor of each sub-student model at a rear stage of the feature extractor.

16. The computing device of claim 15, wherein the plurality of sub-student models has a first loss function, which is a loss function between the predicted value output from the output unit of each sub-student model and a ground truth, a second loss function, which is a loss function between the predicted value output from the output unit of each sub-student model and a predicted value output from the output unit of the teacher model, and a third loss function, which is a loss function between a feature map generated from a block of the feature extractor of each sub-student model and a feature map generated from a block of the corresponding feature extractor of the teacher model.

17. The computing device of claim 16, wherein a total loss function of each sub-student model is expressed by the following equation:
$$ℒ = {λ}_{1} {ℒ}_{ce} + {λ}_{2} {ℒ}_{kd} + {ℒ}_{feature} \qquad [ Equation ]$$
wherein [symbol] ce is first loss function; [symbol]
kd is second loss function; [symbol]
feature is third loss function; and
λ₁ and λ₂ are preset weights.

18. The computing device of claim 10, wherein the one or more programs further include:
an instruction for calculating, if the input image is input to each of the plurality of sub-student models when training of the plurality of sub-student models is completed, a final predicted value based on predicted values output from the plurality of sub-student models.

19. A non-transitory computer readable storage medium storing a computer program including one or more instructions that, when executed by a computing device including one or more processors, cause the computing device to perform:
training a teacher model including a preprocessor that preprocesses an input image to a certain size, a feature extractor including a plurality of sequential blocks for extracting a feature map from the preprocessed input image, and an output unit that outputs a predicted value based on the feature map;
dividing the plurality of sequential blocks of the teacher model into separate blocks, respectively;
generating a plurality of sub-student models by arranging the plurality of divided blocks in parallel; and
training each of the plurality of sub-student models.
